(19) United States
(12) Patent Application Publication
(10) Pub. No.: US 2008/0247026 A1
(43) Pub. Date: Oct. 9, 2008

(54) OPTICAL DIPLEXER WITH LIQUID CRYSTAL TUNABLE WAVEPLATE

(76) Inventor: Irl W. Smith, Concord, MA (US)

Correspondence Address: RAYTHEON COMPANY;c/o DALY, CROWLEY, MOFFORD & DURKEE, LLP, 354A TURNPIKE STREET, SUITE 301A, CANTON, MA, 02021-2714, US

(21) Appl. No.: 12/137,930

(22) Filed: Jun. 12, 2008

Related U.S. Application Data
(62) Division of application No. 11/132,532, filed on May 19, 2005.

(51) Int. Cl. G02F 1/01

(52) U.S. Cl. 359/256

(57) ABSTRACT

An optical diplexer having a birefringent crystal for providing substantially a whole number of wavelength retardation to first optical energy having said first polarization type, and having a first wavelength, fed to a first end of said crystal, and exiting a second end of said crystal with said first polarization type and said first wavelength and for providing substantially an odd integer number of half wavelength retardation to second optical energy having said first polarization type, having a second wavelength, fed to said second end of said crystal and exiting said first end of said crystal with said second polarization type and said second wavelength. The system includes an electronically actuated polarization aligner for adjusting phase retardation of the second energy fed to the second end of the crystal prior to such second energy entering the second end of the birefringent crystal.

### CROSS REFERENCE TO RELATED APPLICATIONS

This application is a divisional application of U.S. patent application Ser. No. 11/132,532 filed on May 19, 2005, which is incorporated herein by reference.

### TECHNICAL FIELD

This invention relates generally to laser optical fiber communication systems and more particularly to optical diplexers used in such systems.

### BACKGROUND

As is known in the art, a laser communication system includes a plurality of transceivers, each one being adapted to transmit optical frequency signals for example a laser transmitter to one or more other transceivers in the system and to receive optical frequency signals transmitted to such one of the transceivers by such one or more other ones of the transceivers.

As is also known in the art, the optical frequencies have been standardized by the International Telecommunications Union (ITU) to be a comb of frequencies beginning with a frequency of 193 TeraHertz (THz) and separated by 100 GHz. Thus, the frequency of any signal, fₖ=193 THz+k (0.1 THz) where k is an integer. The value of k is sometimes referred to as the channel designation. Thus, each transceiver has odd channels, i.e., where k is an odd integer) and even channels (where k is an even integer). Further, for any one of the transceivers, odd channels are used for transmitting signals and the signals received by such one of the transceivers are in even channels, or vice versa (i.e., even channels are used for transmitting signals and the signals received by such one of the transceivers are in odd channels). It should also be noted that the transmitted energy and the received energy have the same type of polarization, e.g., vertical. Thus, it follows that if, for example, two transceivers are to communicate with each one, to provide effective isolation between the receive and transmits channels therein, one of the transceivers uses transmits signals with say vertical polarization in the odd channels and receives signals with vertical polarization in the even channels while the other one of the pair of transceivers transmits signals with vertical polarization in the even channels and receives signals with vertical polarization in the odd channels

As is also known in the art, a diplexer is sometimes used in the transceiver to separate the transmitted and received signals having the same polarization type into separate paths; the transmitted signal emanating from a laser transmitter in the transceivers passing along one path (i.e., a transmit path) and the received signals being directed along a different path to a laser energy receivers in the transceiver (i.e., a receive path).

One such diplexer includes: (1) a birefringent crystal (e.g., retardation wave plate) for providing an integral number of wavelength phase retardation for signals in the, for example, odd channels, e.g., the transmitted signals, and an odd number of half wavelength phase retardation for signals in the received signals; and (2) a polarization beam splitter between the crystal and: (a) the transmitter disposed in the transmit path; and (2) the receiver disposed in the receive path. Thus, during transmit, energy from the transmitter having a frequency in, for example, one of the odd channels, and having, for example, vertical polarization, passes along the transmit path though the polarization beam splitter and then through the crystal as vertically polarized light of the same frequency for external propagation to another one of the transceivers in the system. During receive, energy from the other one of the transceivers in the system, which transmits signal of vertical polarization but, in this example, with a frequency in an even channel, passes though the birefringent crystal; however, here the birefringent crystal changes the polarization in the received signal from vertical polarization to horizontal polarization. The horizontally polarized signal is directed by the polarization bean splitter to the receiver along the receive path.

As is also known in the art, it is important that the length of the optical path through the birefringent crystal be very accurately controlled, which is particularly difficult for high order retardation plates having a thickness of several mm. Furthermore, once an element is fabricated, the optical path length through the element is typically fixed, and is not adjustable. Therefore, if the element is made to the wrong length, the element has to be scrapped and a new one fabricated. One adjustable retardation plate is discussed in U.S. Pat. No. 6,704,143, entitled “Method and apparatus for adjusting an optical element to achieve a precise length”, inventors Han, et al. issued Mar. 9, 2004.

### SUMMARY

In accordance with the present invention, an optical diplexer having a polarizing beam splitter for transmitting a first polarization type and for deflecting a second polarization type. The diplexer includes a birefringent crystal for providing substantially a whole number of wavelength retardation to first optical energy having said first polarization type, and having a first wavelength, fed to a first end of said crystal, and exiting a second end of said crystal with said first polarization type and said first wavelength and for providing substantially an odd integer number of half wavelength retardation to second optical energy having said first polarization type, having a second wavelength, fed to said second end of said crystal and exiting said first end of said crystal with said second polarization type and said second wavelength. The system includes an electronically actuated polarization aligner for adjusting phase retardation of the second energy fed to the second end of the crystal prior to such second energy entering the second end of the birefringent crystal.

In one embodiment, the polarization aligner is an electronically controllable waveplate.

In one embodiment, the polarization aligner includes a pair of the polarization aligner includes a pair of electronically controllable waveplates which, in combination, allows more flexible and precise control of the birefringent retardation.

In one embodiment, the optical diplexer includes a polarizing device disposed: (a) between a source of the second optical energy fed to the second end of the birefringent crystal; and/or (b) between a source of the first optical energy and the first end of the polarizing beam splitter.

In accordance with another feature of the invention, a phase aligner is provided comprising a pair of electronically controllable waveplates having fast axis oriented in different directions.

In one embodiment, the phase aligner includes a fixed birefringent element.

In one embodiment the fixed birefringent element is a waveplate.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagram of an laser optical communication system according to the invention;

FIG. 2 is a block diagram of an exemplary one of a pair of transceivers used in the system of FIG. 1 according to the invention; and

FIG. 3 is a block diagram of an exemplary one of a pair of transceivers used in the system of FIG. 1 according to another embodiment of the invention.

Like reference symbols in the various drawings indicate like elements.

### DETAILED DESCRIPTION

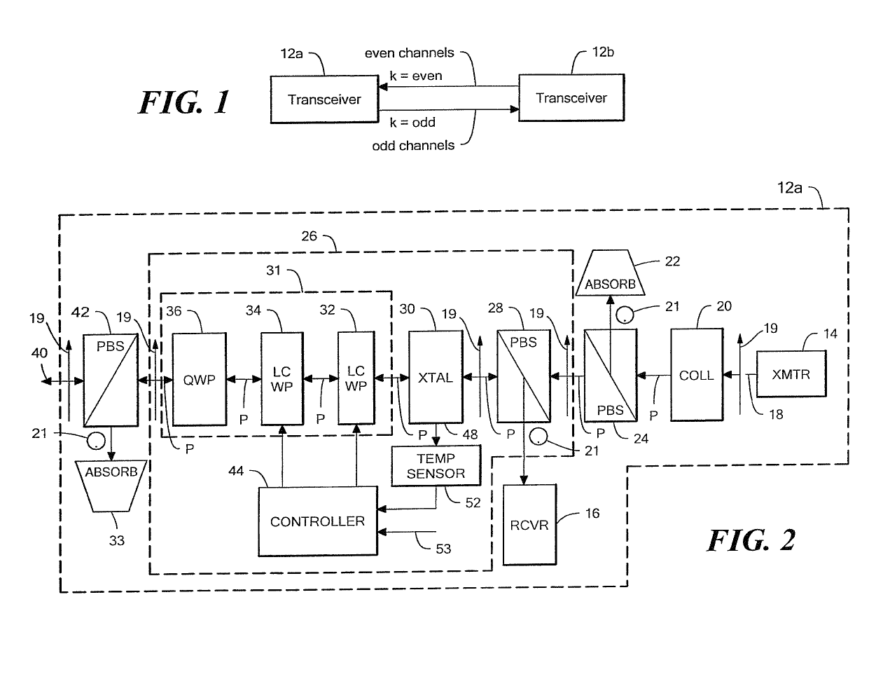

Referring now to FIG. 1, a laser communication system 10 is shown here having a pair of transceivers (XCVRs) 12a, 12b. Transceiver 12a transmits optical communication signals to transceiver 12b using odd channels while transceiver 12b transmits optical communication signals to transceiver 12a using even channels. More particularly, here transceiver 12a transmits optical signals having frequencies fₖ=193 THz+kS, where S is the channel spacing, (e.g., here 0.1 THz) and where k is an odd integer (i.e., odd channels) and transceiver 12b transmits optical signals having frequencies fₖ=193 THz+k (0.1 THz) where k is an even integer (i.e., even channels). It follows then that transceiver 12a includes a receiver, adapted to receive optical signals having frequencies fₖ=193 THz+k (0.1 THz) where k is an even integer and that transceiver 12b includes a receiver adapted to receive optical signals having frequencies fₖ=193 THz+k (0.1 THz) where k is an odd integer.

Referring now to FIG. 2 an exemplary one of the identically constructed transceivers 12a, 12b, here transceiver 12a, is shown to include a laser transmitter 14 and a laser receiver 16. As is well known in the art, additional passive components (not shown) such as lenses and mirrors may lie between the two transceivers for shaping the optical beams, passing them through optical fiber, or sending them through free space. The optical communication signal produced by the laser transmitter 14, indicated by dotted arrow 18, is vertically polarized, indicated by arrows 19, and has the odd channels described above, i.e., k is an odd integer. The light from the transmitter 14 is first passed through a collimator 20. The output of the collimator 20 is passed though a polarization beam splitter 24 so that any here horizontally polarized component, indicated by arrows 21, in the optical energy is directed to an optical energy absorber 22 while only here the vertically polarized energy passes through a polarization beam splitter (PBS) 24 to an electronically controllable birefringent interleaving diplexer 26.

The electronically controllable birefringent interleaving diplexer 26 includes a polarization beam splitter (PBS) 28, a birefringent crystal 30, and a polarization aligner 31. The polarization aligner 31 includes a first electronically controllable waveplate 32, here for example, a liquid crystal waveplate (LCWP) having a 45 degree fast axis orientation relative to the vertical axis, i.e., the fast axis is 45 degrees with respect to the direction as arrow 19, a second electronically controllable waveplate 34, here for example, a liquid crystal waveplate having a vertical fast axis orientation, i.e., the fast axis is along the same direction as the direction as arrow 19, and a fixed birefringent element, here a quarter wave plate QWP 36 having a 45 degree fast axis orientation aligned with the fast axis of the first electronically controllable waveplate 32, i.e., the fast axis is 45 degrees with respect to the direction as arrow 19, all serially arranged as shown along a common optical path indicated by arrows, P.

Thus, the fast axis orientation of the liquid crystal waveplate 32 is different from the fast axis orientation of the liquid crystal waveplate 34.

A polarization beam splitter 42 is disposed between an entrance/exit aperture 40 of the transceiver 12a and the electronically controllable birefringent interleaving diplexer 26. The polarization beam splitter 42 passes vertically polarized light indicated by arrow 19 to entrance/exit aperture 40 and directs horizontally polarized light, indicated by arrow 21 pointing out of the plane of FIG. 2, to an optical energy absorber 33.

The electronically controllable birefringent interleaving diplexer 26 includes a controller 44 for producing electrical signals to the liquid crystal quarter wave plates 32, 34 in a manner to be described.

In order to understand the effect of the crystal 30, let the center frequency of the k^{th} channel be Fₖ and its wavelength be λₖ. These are related by

Fₖ=c/λₖ=F₀+kS (1)

where throughout this discussion when numerical values are given they are understood to be examples for the particular choices of F₀, here 193.0 THz, and S, the channel spacing, here 100.0 GHz, i.e. 0.1 THz; k is an integer. The diplexer 26 is desired to function as a half-wave plate for channels with odd k and as a zero-wave plate for the channels with even k. As is well known in the art, by this is meant that the birefringent retardation L divided by the wavelength be an integer for the even-numbered channels and one-half plus an integer for the odd-numbered channels, i.e.,

$$L = ( {k}_{0} + k ) ( {λ}_{k} / 2 ) = ( {k}_{0} + k ) \frac{c}{2 {F}_{k}} . \qquad ( 2 )$$

where k₀ is an even integer and the second form follows from Eq. 1. This equation gives a relationship which must hold for all k but a fixed value of L, which we may express differently in terms of F₀ and S by solving it for Fₖ and using Eq. 1:

$${F}_{k} = {F}_{0} + kS = \frac{c}{2 L} {k}_{0} + \frac{c}{2 L} k . \qquad ( 3 )$$

This is satisfied by the following choice of the birefringent retardation and the integer k₀:

$$L = {L}_{0} ≡ \frac{c}{2 S} \approx 1.5 mm ; \\ {k}_{0} = \frac{{F}_{0}}{S} = 1930 ; \\ note \frac{{L}_{0}}{{k}_{0}} = \frac{{λ}_{0}}{2} . \qquad ( 4 )$$

Thus, with L=L₀≡c/2S=1.499 millimeter (mm) here, a retardation is provided which varies in a prescribed way with wavelength, i.e., changes by one-half a wavelength as the optical frequency changes by 100 GHz.

As will now be shown, the roles of even-k and odd-k channels may be interchanged by appropriate setting of the variable waveplates 32, 34. As will be discussed, such setting results in a change in the total birefringence and thus acts a small change of L away from its nominal value L₀, viz., L=L₀+d. The new frequency of the kth channel will be given by solving Eq. 2 for the values Fₖ., denoted (for L shifted by d) F′ₖ. Performing this algebra one finds that the shift in the kth channel from its nominal (i.e., for d=0) value is given by

Fₖ−F′ₖ={(k₀+k)d/(L₀+d)}S. (5)

Noting that k₀ is large compared with unity, we may choose d to be a certain (small) value such that the term in curly braces equals unity for k=0. The necessary value of d is (cf. Eq. 4) approximately λ₀/2, where λ₀ is the wavelength of the zeroth channel. The shift of the zero-th channel (i.e. the one with k=0) is exactly S, i.e. this even channel has shifted to an odd-channel frequency. The shift will be approximately S as long as k is small compared with k₀. For example, over a span of 40 channels covering the conventional laser-communication band, the shift will be within 40/1930=2% of S. Such small frequency errors are acceptable for an interleaver to be used with many laser communication systems.

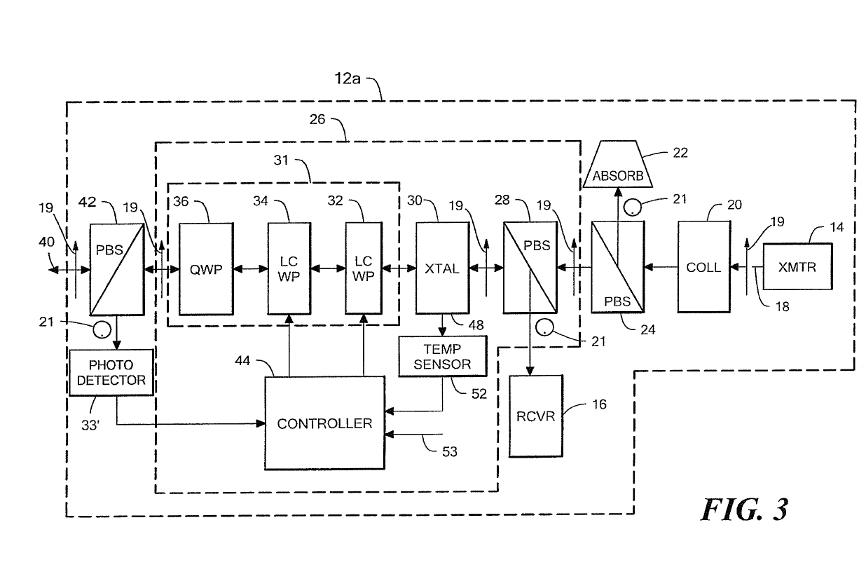

The LCWP 32 adjacent to the fixed crystal 30 is preferably oriented so that its birefringent fast axis is parallel with that of the crystal 30. Thus, electrically varying its retardation, as is well known in the art of liquid crystal variable retarders, directly changes the total birefringence of the two elements, crystal 48 plus LCWP 32. For cases where the LCWP 32 has a highly stable fast axis as a function of voltage, or where the system requirements are not too stringent, these two elements (LCWP 32 plus crystal 48) are all that are required for proper diplexer operation. The control voltage for this LCWP 32 is set so that the combination of the LCWP 32 and the crystal 48 results in the desired total retardation. However, provision of a second LCWP 34 allows compensation for imperfections in the whole system as will now be described. In this case, the control voltage for this LCWP 32 is set so that the combination of the LCWP 32 and the crystal 48 results in an excess retardation of a quarter wave, resulting in circular polarization of the light which enters the crystal from the right as linear (vertical) polarization. Since real LCWP 32 may have a slightly variable fast axis, the second LCWP 34 is oriented with its fast axis at approximately 45° to that of LCWP 32. This permits effectively adjusting the birefringemnt fast axis of the combination of LCWPs 32 and 34 to be exactly aligned at 45 degrees. Small changes in the control voltage of the two LCWP's 32, 34 allows achieving very pure circular polarization of light exiting LCWP 34. The remaining element, i.e., the fixed quarter-wave plate 36, is oriented with its fast axis along the slow axis of the LCWP 32, thereby converts the light to the desired linear polarization. Thus, the combination of three elements serially arranged LCWP 32, LCWP 34, and fixed quarter-wave plate 36 disposed along the common path indicated by the arrows, P, act like a very pure electrically variable retardation which may be set from zero to some positive value, effectively controlling the total birefringent retardation of the polarization aligner in its entirety. The control signals may be developed in a manner as shown in FIG. 2 and/or in a closed-loop manner by providing the absorber 33 with a photodetector 33′ as shown in FIG. 3 and using familiar hill-climbing servo techniques to minimize the power incident thereunto.

Thus, referring to the arrangement shown in FIG. 2, very small errors from temperature variations in the crystal 30 retardation are corrected. That is, the retardation L changes with temperature. This temperature error correction signal may be generated by including a thermocouple or other temperature-sensing device 52 (FIG. 2). The signal from the temperature sensing device 52 is compared with a reference signal on line 53 representative of a nominal temperature condition at which the crystal provides the ideal phase retardation L. Variations from the reference signal thus represents an error signal related to the variation of the actual retardation of the crystal, ΔL, from the ideal retardation, L, which generates the required voltages for the liquid crystals 32, 34 to thereby compensate for the temperature effects on the crystal retardation. The error should be negligible over the ±20 nm (i.e., ±2.5 THz) band used for laser communications.

It is noted that the crystal 30 is a high order waveplate having a length in combination with aligner 31 selected to provide a phase retardation L such that optical signals having wavelengths in the odd channels experience a phase retardation of a whole number of wavelengths and thus pass therethrough without a change in polarization whereas optical signal having wavelengths in the even channels experience a phase retardation of an odd number of half wavelengths to thereby rotate the polarizations of such optical signals by 90 degrees, i.e., vertically polarized optical signals having wavelengths in the even channels are converted into horizontally polarized optical signals.

In operation, optical communication signals from transmitter 14 have frequencies fₖ=193 THz+k (0.1 THz) where k is an odd integer (i.e., the odd channels) and pass, after collimation by collimator 20, through polarization beam splitter 24. The vertically polarized light, having frequencies fₖ=193 THz+k (0.1 THz) where k is an odd integer, pass, as vertically polarized light, though the electronically controllable birefringent interleaver 26 and then through the polarization beam splitter 42 to the through the entrance/exit aperture 40 for transceiver 12b. It is noted in the signals provided by the controller 44 are used to compensate for any temperature effects on the retardation L of the crystal 28 as well as to perform the interchange of the roles of even and odd channels as desired.

During receive, optical communication signals from transceiver 12b having frequencies fₖ=193 THz+k (0.1 THz) where k is an even integer (i.e., an even channels), pass through polarization beam splitter 42 as vertically polarized light, any horizontal components being directed to an absorber 32. The vertically polarized light, having frequencies fₖ=193 THz+k (0.1 THz) where k is an even integer, pass, as vertically polarized light, though the electronically controllable birefringent interleaving diplexer 26; here, however, because the received optical signals are in the even channels, the crystal 30 in combination with aligner 31 provides an odd number of half wavelengths to such received optical signals and thereby converts such received optical signals to horizontally polarized light. The horizontally polarized light in the received signals is then directed by the polarization beam splitter 28 to the receiver 16.

From Eq. 3, above, it was shown that choosing L=c/2S, i.e. L=1.499 millimeter (mm), will simultaneously satisfy the equations for all k whether k is odd or k is even. It should be noted that if L is “detuned” by a half-wave, the even and odd channels will be interchanged. This “detuning” is performed by providing proper voltages to the liquid crystal waveplates. Thus, the same transceiver may be used for transceiver 12a and 12b; one, here transceiver 12b, having a voltage applied to the liquid crystal waveplates 32, 34 to establish the “detuned” while transceiver 12a does not have the “detuned” retardation.

Thus, the use of the polarization aligner 31 enables both transceivers 12a, 12b, FIG. 1, to be constructed identically (i.e., with the same crystal 30 retardation, L). More particularly, referring to FIG. 1, and assuming that neither transceiver 12a, 12b includes the polarization aligner 31 (FIG. 2), the transceiver 12a must have a crystal 30 with a different retardation L than the corresponding retardation in transceiver 12b in order to communicate with transceiver 12b. Thus, two types of transceivers would be required, i.e., transceivers with different crystals 30. When the transceivers incorporate polarization aligners 31, both transceivers may have the same nominal crystal retardation, L≃L₀, and the voltages applied to the polarization aligner 31 of one of the transceivers would be different from the other one of the transceivers to provide the requisite additional odd number of half wavelength retardation to one of the two transceivers. Provision of the polarization aligners 31 also allows simultaneously providing any necessary compensation for temperature effects and also for small errors in fabrication of the two crystals as described above.

As is known, the state of polarization of a light wave is defined by two parameters (e.g., orientation and aspect ratio or “ellipticity” of the polarization ellipse). To change a polarization from an arbitrary given state A to a given state B therefore requires, in general, two degrees of freedom (“2DOF”). In accordance with the invention, those are the settings (voltages) of two LCWP's 32, 34 of the polarization aligner 31. The input states to the polarization aligner 31 result from the operation by the crystal 30, having known and fixed fast axis but somewhat variable retardation, on the lightwaves just to its right, which are vertically or horizontally polarized. The resulting states to the left of crystal 30 have known orientation, namely, vertical/horizontal, and variable ellipticity. The 2DOF polarization controller comprising LCWP's 32 and 34 can transform any such state into perfect circular polarization, or in fact to any state near perfect circular, but not in general to perfect vertical polarization. Thus a fixed birefringent element, here QWP 36, is used to transform the set of states near circular to a set of states near vertical. Even in the presence of small errors in the orientation and retardation of the fixed birefringent element QWP 36, there will be a state near circular which is transformed into perfect vertical polarization by that element. That state is within the available output space of the 2DOF polarization aligner comprising the two LCWP's 32 and 34. Thus, here in the diplexer 26, the polarization aligner having two LCWP's 32, 34 with a fixed QWP 38 to their left provides the desired control.

A number of embodiments of the invention have been described. Nevertheless, it will be understood that various modifications may be made without departing from the spirit and scope of the invention. Accordingly, other embodiments are within the scope of the following claims.

What is claimed is:

1. An optical diplexer, comprising:
a polarizing beam splitter for transmitting a first polarization type and for deflecting a second polarization type;
a birefringent crystal for providing substantially a whole number of wavelength retardation to first optical energy having said first polarization type, and having a first wavelength, fed to a first end of said crystal, and exiting a second end of said crystal with said first polarization type and said first wavelength and for providing substantially an odd integer number of half wavelength retardation to second optical energy having said first polarization type, having a second wavelength, fed to said second end of said crystal and exiting said first end of said crystal with said second polarization type and said second wavelength; and
an electronically actuated polarization aligner for adjusting phase retardation of the second energy fed to the second end of the crystal prior to such second energy entering the second end of the birefringent crystal.

2. The diplexer recited in claim 1 wherein the polarization aligner includes an electronically controllable waveplate.

3. The system recited in claim 2 wherein the polarization aligner includes a pair of electronically controllable waveplates.

4. The system recited in claim 3 wherein the optical diplexer includes a polarizing device disposed: (a) between a source of the second optical energy fed to the second end of the birefringent crystal; and/or (b) between a source of the first optical energy and the first end of the polarizing beam splitter.

5. An adjustable birefringent phase retardation system, comprising:
a birefringent crystal for providing substantially a whole number of wavelength retardation to first optical energy having a first polarization type, having a first wavelength, fed to a first end of said crystal, and exiting a second end of said crystal with said first polarization type and said first wavelength and for providing substantially an odd number of half wavelength retardation to second optical energy having said first polarization type, having a second wavelength, fed to said first end of said crystal and exiting said first end of said crystal with said first polarization type and said second wavelength; and
an electronically controllable polarization aligner for adjusting phase retardation of the second energy fed to the second end of the crystal prior to such second energy entering he second end of the birefringent crystal.

6. The adjustable birefringent phase retardation system recited in claim 5 wherein the electronically controllable polarization aligner is an electronically controllable waveplate.

7. The adjustable birefringent phase retardation system recited in claim 5 wherein the electronically controllable polarization aligner includes a pair of electronically controllable waveplates, one of such waveplates having a fast axis oriented in one direction and the other one of such waveplates having a fast axis oriented in a different direction.

8. The adjustable birefringent phase retardation system recited in claim 5 including a polarization beam splitter disposed: (a) between a source of the first optical energy fed to the first end of the birefringent crystal and the birefringent crystal; and/or (b) between a receiver of the second optical energy exiting the first end of the birefringent crystal and the the birefringent crystal.

9. The adjustable birefringent phase retardation system recited in claim 6 wherein the electronically controllable polarization aligner includes a fixed waveplate.

10. The adjustable birefringent phase retardation system recited in claim 7 wherein the electronically controllable polarization aligner includes an electronically controllable waveplate.

11. The adjustable birefringent phase retardation system recited in claim 8 wherein the electronically controllable phase retardation system includes a pair of electronically controllable waveplates, one of such waveplates having a fast axis oriented in one direction and the other one of such waveplates having a fast axis oriented in a different direction.

12. The adjustable birefringent phase retardation system recited in claim 10 wherein the electronically controllable phase retardation system includes an electronically controllable liquid crystal waveplate.
